(19) United States
(12) Patent Application Publication
(10) Pub. No.: US 2019/0114412 A1
(43) Pub. Date: Apr. 18, 2019

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Zhenrui ZHANG, Kanagawa (JP)

(73) Assignee: FUJI XEROX CO., LTD., Tokyo (JP)

(21) Appl. No.: 16/153,837

(22) Filed: Oct. 8, 2018

(30) Foreign Application Priority Data
Oct. 18, 2017 (JP) 2017-202038

(51) Int. Cl. G06F 21/41; G06F 21/62; G06F 21/12

(52) U.S. Cl. CPC G06F 21/41; G06F 21/121; G06F 21/6245

(57) ABSTRACT

An information processing apparatus includes a receiving unit that receives an authentication request using first account information identifying an account for use of a service provided by a linkage source; and an inquiring unit that, in a case where the received first account information is associated with second account information identifying an account for use of a service provided by an external authentication apparatus, inquires the external authentication apparatus as to whether or not the second account information is registered.

### CROSS-REFERENCE TO RELATED APPLICATIONS

This application is based on and claims priority under 35 USC 119 from Japanese Patent Application No. 2017-202038 filed Oct. 18, 2017.

### BACKGROUND

### (i) Technical Field

The present disclosure relates to an information processing apparatus, an information processing system, and a non-transitory computer readable medium.

### (ii) Related Art

In recent years, a single sign-on system that allows a user to use plural services just by single log-on has been proposed (see, for example, Japanese Unexamined Patent Application Publication No. 2013-149238).

In the single sign-on system described in Japanese Unexamined Patent Application Publication No. 2013-149238, a mapping table in which a user account (linkage source account) in a linkage-source website and a user account (linkage partner account) in a linkage-partner website are associated is stored, account information in the linkage-source website is acquired, the acquired account information is converted into account information in the linkage-partner website by using the mapping table, and the account information is returned to a user so that the linkage-partner website is accessed by using the converted account information.

### SUMMARY

In a case of authentication linkage using only a table in which a linkage source account and a linkage partner account are associated, the linkage partner account is sometimes no longer registered in the linkage partner when a user tries to use a service provided by a host apparatus. In such a case, use of the service is undesirably permitted for an account that does not exist in the linkage partner.

Aspects of non-limiting embodiments of the present disclosure relate to an information processing apparatus, an information processing system, and a non-transitory computer readable medium that, in a case where an authentication request is made by using a linkage source account and where the linkage source account is associated with an account in an external authentication apparatus, make it possible to check validity of the account in the external authentication apparatus without need for secret information such as a password.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the disclosure, there is provided an information processing apparatus including a receiving unit that receives an authentication request using first account information identifying an account for use of a service provided by a linkage source; and an inquiring unit that, in a case where the received first account information is associated with second account information identifying an account for use of a service provided by an external authentication apparatus, inquires the external authentication apparatus as to whether or not the second account information is registered.

An exemplary embodiment of the present disclosure will be described in detail based on the following figures, wherein:

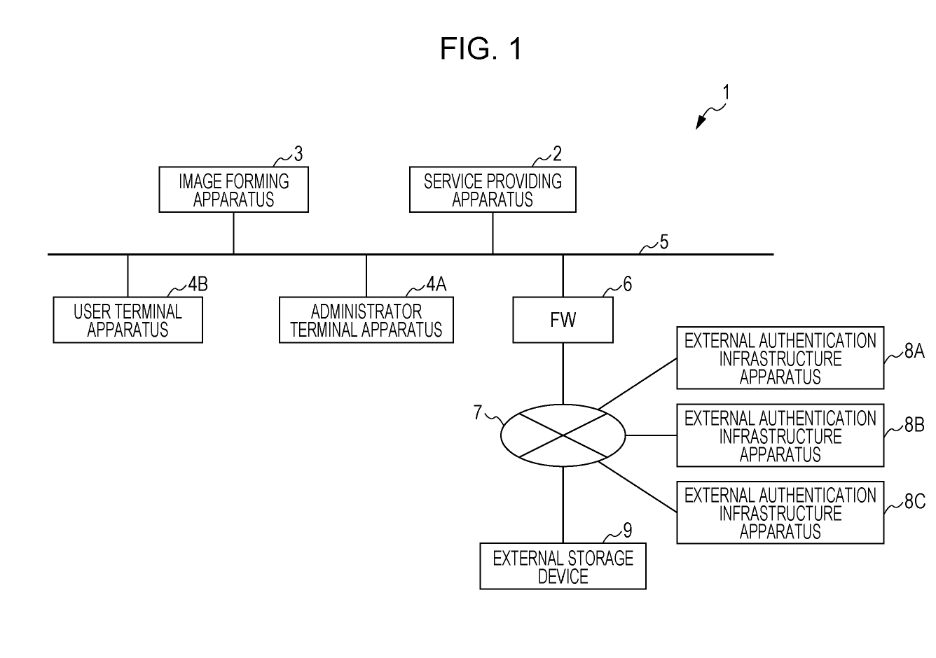

FIG. 1 illustrates an example of a configuration of a service providing system according to an exemplary embodiment of the present disclosure;

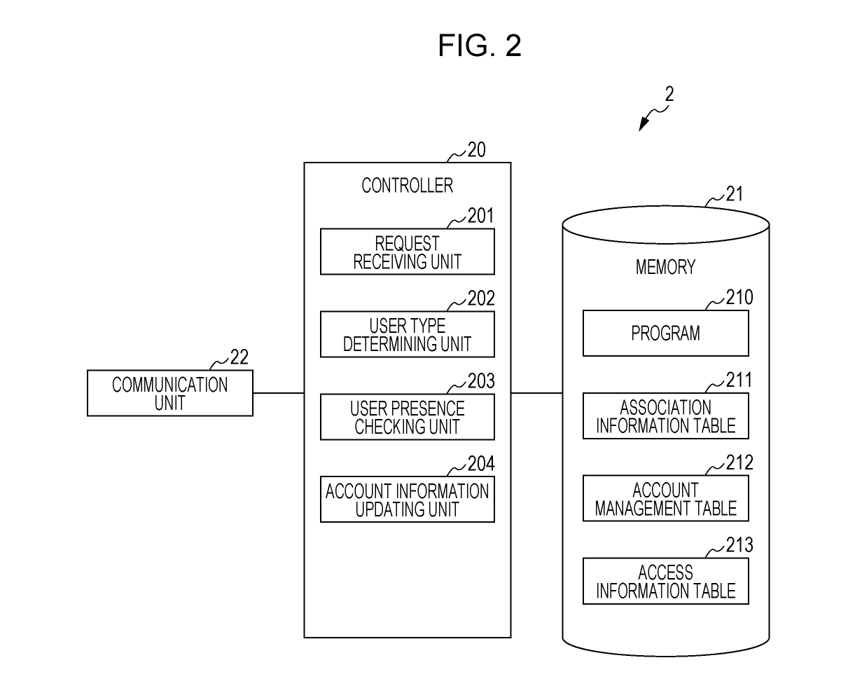

FIG. 2 illustrates an example of a control system of a service providing apparatus;

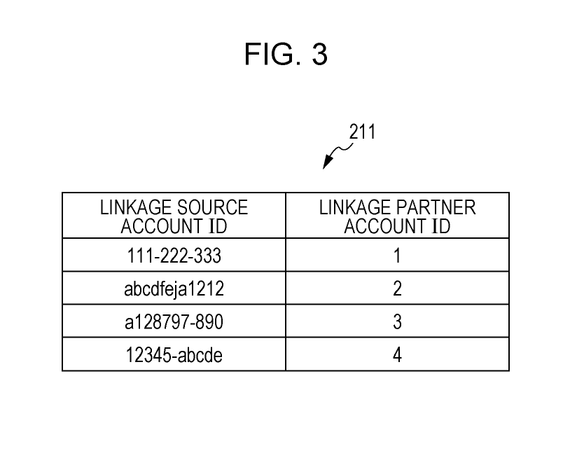

FIG. 3 illustrates an example of an association information table;

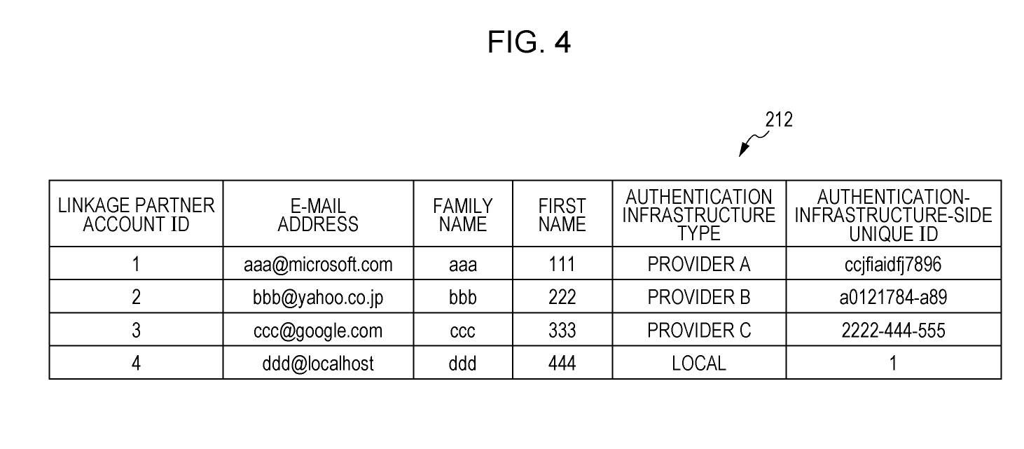

FIG. 4 illustrates an example of an account management table;

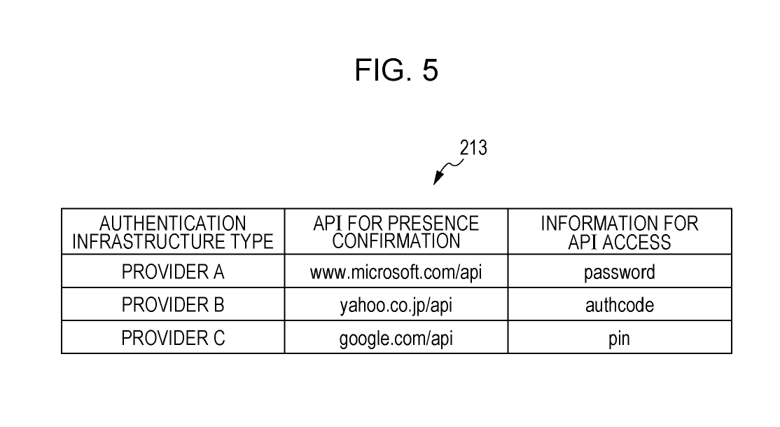

FIG. 5 illustrates an example of an access information table;

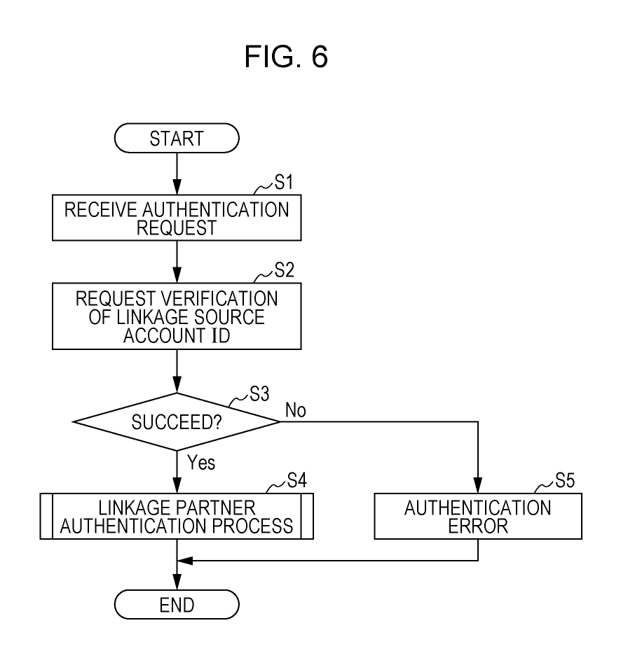

FIG. 6 is a flowchart illustrating an example of operation of the service providing apparatus; and

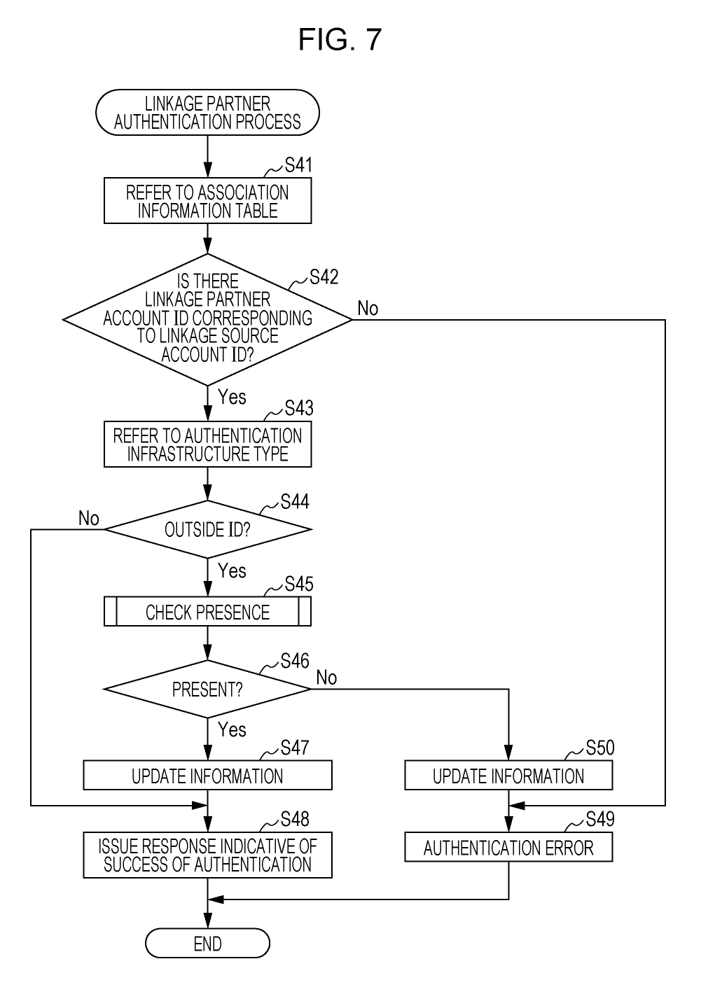

FIG. 7 is a flowchart illustrating an example of operation of the service providing apparatus.

### DETAILED DESCRIPTION

An exemplary embodiment of the present disclosure is described below with reference to the drawings. In the drawings, constituent elements having substantially identical functions are given identical reference signs, and repeated description thereof is omitted.

### Overview of Exemplary Embodiment

An information processing apparatus according to an exemplary embodiment of the present disclosure includes a receiving unit that receives an authentication request using first account information identifying an account for use of a service provided by a linkage source; and an inquiring unit that, in a case where the received first account information is associated with second account information identifying an account for use of a service provided by an external authentication apparatus, inquires the external authentication apparatus as to whether or not the second account information is registered.

The “account” refers to a right to log in to a service provider. The “account information” refers to information uniquely identifying an account and is, for example, an account ID. Examples of a “service provided by the information processing apparatus” include a service linked with an outside (e.g., a server or a website) connected to an external network such as the Internet. The “external authentication apparatus” refers to an apparatus having an authentication function that is connected to an external network such as the Internet. The “authentication” refers to acknowledging that a user (examples of which include an administrator) of a terminal apparatus is a user registered in advance on the basis of authentication information.

### Exemplary Embodiment

FIG. 1 illustrates an example of a configuration of a service providing system according to an exemplary embodiment of the present disclosure. This service providing system 1 includes a service providing apparatus 2, an image forming apparatus 3, an administrator terminal apparatus 4A, and a user terminal apparatus 4B.

The service providing apparatus 2, the image forming apparatus 3, the administrator terminal apparatus 4A, and the user terminal apparatus 4B are connected to one another over an internal network 5.

The internal network 5 is connected to an external network 7 such as the Internet through a firewall (FW) 6. Plural (for example, three) external authentication infrastructure apparatuses 8A, 8B, and 8C (sometimes collectively referred to as “external authentication infrastructure apparatuses 8”) and an external storage device 9 are provided on the external network 7.

An internal network 5 side with respect to the firewall 6 is referred to as a “service side”. The administrator terminal apparatus 4A is used by an administrator. The user terminal apparatus 4B is used by a user other than the administrator.

The service providing system 1 is an example of an information processing system. The service providing apparatus 2 is an example of an information processing apparatus. The number of image forming apparatuses 3 is not limited to one, and plural image forming apparatuses 3 may be provided. Although a single user terminal apparatus 4B is illustrated in FIG. 1, plural user terminal apparatuses 4B are generally connected to the internal network 5. The user terminal apparatus 4B is an example of an authentication requestor. The administrator terminal apparatus 4A and the user terminal apparatus 4B are sometimes collectively referred to as terminal apparatuses 4. The external authentication infrastructure apparatuses 8 are an example of an external authentication apparatus and a linkage partner. The number of external storage devices 9 is not limited to one, and plural external storage devices 9 may be provided. The external storage device 9 is an example of a linkage source. The service providing apparatus 2 can be a linkage partner in a case where the external storage device 9 is a linkage source. Each of the external authentication infrastructure apparatuses 8 can be a linkage partner in a case where the external storage device 9 or the service providing apparatus 2 is a linkage source.

The service providing apparatus 2 performs an authentication process for determining whether or not authentication information (e.g., a user ID and a password) of a user is correct and then performs a permission process for determining whether or not the user has an authority to use a service. In a case where the user has an account for use of a service provided by any of the external authentication infrastructure apparatuses 8, the service providing apparatus 2 performs the permission process without performing the authentication process. This realizes single sign-on. Single sign-on allows a user to use plural services just by being authenticated once. The service providing apparatus 2 permits a user who has been authorized and permitted to use a service over the internal network 5. Examples of a service (hereinafter referred to as a “subject service”) provided by the service providing apparatus 2 include a print service, a storage service linked with the external storage device 9, and an external print service linked with an external cloud server on the external network 7. The external print service is a service for printing out from a printer managed by the external cloud server.

The image forming apparatus 3 is, for example, a multifunction printer having plural functions such as a copy function, a scan function, a print function, and a facsimile function. The image forming apparatus 3 includes a controller that is constituted by a CPU, an interface, and the like and controls each unit of the image forming apparatus 3, a storage unit in which a program for the CPU and various kinds of data are stored, and an operation display unit that displays various screens and receives operation on a screen. The program includes a web browser for web page browsing. The operation display unit has, for example, a touch panel display configured such that a touch panel is superimposed on a display such as a liquid crystal display. The image forming apparatus 3 becomes a candidate for a destination of print output in a case where the print service provided by the service providing apparatus 2 is used.

The administrator terminal apparatus 4A includes a controller that is constituted by a CPU, an interface, and the like and controls each unit of the administrator terminal apparatus 4A, a storage unit in which a program for the CPU and various kinds of data are stored, an input unit constituted by a keyboard, a mouse, and the like, and a display constituted by a liquid crystal display or the like. The program includes a web browser for web page browsing. The administrator terminal apparatus 4A can be, for example, an information processing apparatus such as a personal computer (PC) or a multifunction mobile phone (smartphone). The user terminal apparatus 4B has a configuration similar to the administrator terminal apparatus 4A.

The internal network 5 is a computer network that connects a computer and an apparatus in an organization such as a company and is, for example, a local area network (LAN) or an intranet. The internal network 5 may be a wired network or may be a wireless network.

A purpose of the firewall 6 is to prevent illegal access or intrusion from an outside and is set so as to allow passage of a request from the terminal apparatus 4 to the external network 7 and a response to the request but not to allow passage of a request from the external network 7 side to the terminal apparatus 4.

The external authentication infrastructure apparatuses 8 are, for example, managed by ID providers (also called authentication providers) such as Microsoft, Yahoo, and Google. These ID providers provide social network services (SNS) by service names of Microsoft Azure Active Directory (AD) (Microsoft and Active Directory are registered trademarks), Yahoo! (registered trademark), and Google Accounts (Google is registered trademark). Hereinafter, ID providers that manage the external authentication infrastructure apparatuses 8A, 8B, and 8C are referred to as a “provider A”, a “provider B”, and a “provider C”, respectively.

The external storage device 9 provides a storage service for storing data, programs, and the like on a cloud (the external network 7 in this example). Although a special account ID (linkage source account ID) is needed for used of the storage service provided by the external storage device 9, a user authorized by a linkage partner ID for any of the external authentication infrastructure apparatuses 8 can use this service.

FIG. 2 illustrates an example of a control system of the service providing apparatus 2. The service providing apparatus 2 includes a controller 20 that controls each unit of the service providing apparatus 2, a memory 21 in which various kinds of information are stored, and a communication unit 22.

The controller 20 is constituted by a central processing unit (CPU), an interface, and the like. The CPU operates in accordance with a program 210 stored in the memory 21 and thus functions as a request receiving unit 201, a user type determining unit 202, a user presence checking unit 203, an account information updating unit 204, and the like. The user presence checking unit 203 is an example of an inquiring unit and a permission unit. Details of the units 210 through 204 will be described later.

The memory 21 is constituted by a read only memory (ROM), a random access memory (RAM), a hard disk, and the like and stores therein the program 210, an association information table 211 (see FIG. 3), an account management table 212 (see FIG. 4), an access information table 213 (see FIG. 5), and the like. In the present specification, the term “record” or “register” is used in a case where information is written into a table, and the term “store” is used in a case where information is written into a memory.

The communication unit 22 is constituted by a network interface card (NIC) or the like and communicates with the image forming apparatus 3 and the terminal apparatus 4 over the internal network 5 and communicates with external apparatuses such as the external authentication infrastructure apparatuses 8 and the external storage device 9 over the internal network 5, the FW 6, and the external network 7.

FIG. 3 illustrates an example of the association information table 211. The association information table 211 includes items such as a linkage source account ID and a linkage partner account ID. In the linkage source account ID field, an account ID given to a user by the external storage device 9 that serves as a linkage source is recorded. In the linkage partner account ID field, an account ID given to a user by the service providing apparatus 2 or any of the external authentication infrastructure apparatuses 8 that serves as a linkage partner is recorded.

The linkage source account ID is identification information of an account for user's use of a service of a linkage source and is information uniquely identifying the user in the linkage source. The linkage partner account ID is identification information of an account for user's use of a service of a linkage partner and is information uniquely identifying the user in the linkage partner. The linkage source account ID and the linkage partner account ID are examples of authentication information and association information. The linkage source account ID is an example of first account information. A linkage partner account ID for use of a service provided by any of the external authentication infrastructure apparatuses 8 is an example of second account information. A linkage partner account ID for use of a service provided by the service providing apparatus 2 is an example of third account information.

When a user first logs in to the external storage device 9 that serves as a linkage source by using the user terminal apparatus 4B and is authenticated by transmission of authentication information (e.g., an e-mail address and a password) from the user terminal apparatus 4B to the external storage device 9, authentication result information (e.g., an authentication result, a linkage source account ID, an e-mail address, and the like) is supplied from the external storage device 9 to the service providing apparatus 2. Furthermore, when the user selects any of the external authentication infrastructure apparatuses 8 as a linkage partner on a linkage partner selection screen displayed on the user terminal apparatus 4B and is authenticated by transmission of authentication information (e.g., a user ID and a password) from the user terminal apparatus 4B to the external authentication infrastructure apparatus 8, authentication result information (e.g., an authentication result, a linkage partner account ID, a user ID, a name, a directory ID, an e-mail address, and the like) is supplied from the external authentication infrastructure apparatus 8 to the service providing apparatus 2. The controller 20 of the service providing apparatus 2 causes the linkage source account ID and the linkage partner account ID included in the supplied authentication result information to be registered in the association information table 211 in association with each other. The “directory” refers, for example, to a department, a group, a team, or the like in a company to which a user belongs. The directory ID is identification information identifying a directory. The “associating” as used herein refers to relating.

FIG. 4 illustrates an example of the account management table 212. The account management table 212 includes items such as a linkage partner account ID, an e-mail address, a family name, a first name, an authentication infrastructure type, an authentication-infrastructure-side unique ID, a directory ID (not illustrated), and a tenant ID (not illustrated). In the linkage partner account ID field, an account ID given by the same linkage partner as the association information table 211 illustrated in FIG. 3 is recorded. In the e-mail address field, an e-mail address of the user terminal apparatus 4B used by a user is recorded. The e-mail address is an example of address information. In the family name field, a family name of the user is recorded. In the first name field, a first name of the user is recorded. In the authentication infrastructure type field, a name of a provider that manages the external authentication infrastructure apparatus 8 or “local” indicative of the service providing apparatus 2 is recorded. In the authentication-infrastructure-side unique ID field, an ID for confirming that the user is present in the linkage partner is recorded. In the directory ID field, a directory ID included in authentication result information supplied from the external authentication infrastructure apparatus 8 is recorded. In the tenant ID field, a tenant ID corresponding to a directory ID is recorded. The authentication-infrastructure-side unique ID is an example of identification information for confirmation of registration of second account information. The authentication-infrastructure-side unique ID is used to authenticate an administrator by the external authentication infrastructure apparatus 8 when the linkage source account ID and the linkage partner account ID are associated with each other. The “tenant” refers, for example, to an organization such as a department, a group, or a team in a company that can be accessed by a user and sometimes encompasses an organization to which the user belongs. The tenant ID is identification information identifying a tenant.

FIG. 5 illustrates an example of the access information table 213. The access information table 213 includes items such as an authentication infrastructure type, an application programming interface (API) for presence confirmation, and information for API access. In the authentication infrastructure type field, a name of a provider that manages the external authentication infrastructure apparatus 8 is recorded. In the API for presence confirmation field, an API is recorded. In the information for API access field, information for access to the API is recorded. The API is an interface that defines a procedure, a data format, and the like for calling up a software function from an outside (the program 210 of the service providing apparatus 2 in this example) and using the software function. In a case where the service providing apparatus 2 gives a read request to the external authentication infrastructure apparatus 8 by using an API, the external authentication infrastructure apparatus 8 returns read data (data indicative of the presence of the user). The API for presence confirmation and information for API access are opened to the public by the external authentication infrastructure apparatus 8, and the API for presence confirmation and information for API access are acquired by the service providing apparatus 2 in advance and are recorded in the access information table 213.

The memory 21 stores therein the association information table 211 in which a linkage source account ID and a linkage partner account ID are registered in association with each other and the account management table 212 in which the linkage partner account ID and an authentication-infrastructure-side unique ID are registered in association with each other and thus stores therein the linkage source account ID, the linkage partner account ID, and the authentication-infrastructure-side unique ID in association with each other.

Next, the units 201 through 204 of the service providing apparatus 2 are described.

The request receiving unit 201 receives an authentication request using a linkage source account ID from the user terminal apparatus 2B.

The user type determining unit 202 determines whether or not there is a linkage partner account ID corresponding to a linkage source account ID supplied from the request receiving unit 201 while referring to the association information table 211. Furthermore, the user type determining unit 202 determines whether the linkage partner is an outside (the external authentication infrastructure apparatus 8) or not (local) while referring to the account management table 212.

The user presence checking unit 203 checks whether or not a user having the linkage partner account ID is present in a case where it is determined that the linkage partner is an outside by the user type determining unit 202. That is, the user presence checking unit 203 accesses the API for presence confirmation of the access information table 213 and inquires the external authentication infrastructure apparatus 8 as to whether or not the linkage partner account ID is registered by using the authentication-infrastructure-side unique ID and the information for API access.

Furthermore, the user presence checking unit 203 permits use of a subject service within a range of authority set for the tenant ID in a case where a response indicating that the linkage partner account is registered is received from the linkage partner. In a case where the linkage partner account ID is an account for use of a service of the service providing apparatus 2, the user presence checking unit 203 permits use of the subject service within a range of authority set for the tenant ID without inquiry.

Furthermore, in a case where plural authentication-infrastructure-side unique IDs are acquired, the user presence checking unit 203 presents a selection screen to the user terminal apparatus 4B that is an authentication requestor so as to promote the user to select any of the plural authentication-infrastructure-side unique IDs.

The account information updating unit 204 updates the account management table 212 by using information acquired from the external storage device 9 and the external authentication infrastructure apparatus 8 in a case where the user presence checking unit 203 has confirmed that the linkage partner account ID is registered. Furthermore, the account information updating unit 204 updates the association information table 211 and the account management table 212 by deleting a corresponding record in a case where the user presence checking unit 203 has confirmed that the linkage partner account ID is not registered.

### Operation of Exemplary Embodiment

Next, an example of operation of the service providing system 1 is described with reference to the flowcharts of FIGS. 6 and 7.

(1) Flow from Receipt of Authentication Request to Start of Authentication

When the request receiving unit 201 of the service providing apparatus 2 receives an authentication request concerning a linkage source account ID from the user terminal apparatus 4B (S1), the controller 20 verifies the linkage source account ID. That is, the controller 20 transmits the linkage source account ID to a linkage source and requests verification as to whether or not the linkage source account ID is genuine (S2). In a case where the controller 20 receives a result of verification indicative of success of verification from the linkage source (Yes in S3), the controller 20 performs a linkage partner authentication process illustrated in FIG. 7 (S4).

In a case where the controller 20 receives a result of verification indicative of failure of verification from the linkage source (No in S3), the controller 20 notifies the user terminal apparatus 4B about an authentication error (S5).

### (2) Linkage Partner Authentication Process

The user type determining unit 202 determines whether or not there is a linkage partner account ID corresponding to the linkage source account ID supplied from the request receiving unit 201 while referring to the association information table 211 illustrated in FIG. 3 (S41). For example, in a case where the linkage source account ID is “111_222_333”, it is determined that there is a corresponding linkage partner account ID “1”.

In a case where there is a linkage partner account ID corresponding to the linkage source account ID (Yes in S42), the user type determining unit 202 refers to the authentication infrastructure type field corresponding to the linkage partner account ID in the account management table 212 illustrated in FIG. 4 (S43) and determines whether or not the linkage partner is an outside (S44). For example, in a case where the authentication infrastructure type is not local, it is determined that the linkage partner is an outside. In a case where the linkage partner account ID is “1”, a corresponding authentication infrastructure type is the provider A, and it is therefore determined that the linkage partner is an outside. In a case where plural linkage partner account IDs that correspond to the linkage source account ID are registered in the association information table 211, a screen showing a list of the corresponding linkage partner account IDs is displayed on the user terminal apparatus 4B so as to promote the user to select a linkage partner. The user sometimes cannot recognize an authentication infrastructure type from a linkage partner account ID. In view of this, for example, authentication infrastructure types corresponding to the linkage partner account IDs may be specified by referring to the account management table 212, and the screen showing a list of the corresponding linkage partner account IDs may be arranged on the basis of the specified authentication infrastructure types. On this screen, only authentication infrastructure types indicative of outside linkage partners may be displayed or all authentication infrastructure types including local may be displayed.

In a case where the linkage partner is an outside (Yes in S44), the presence of a user having the linkage partner account ID is checked (S45). That is, the user presence checking unit 203 accesses the API for presence confirmation in the access information table 213 illustrated in FIG. 5 and inquires the external authentication infrastructure apparatus 8 that is an outside as to whether or not the linkage partner account ID is registered by using the authentication-infrastructure-side unique ID and the information for API access. Since the authentication-infrastructure-side unique ID and the information for API access are used in the process for checking the presence of the user, secret information such as a password is not necessary.

In a case where a response indicating that the user is present is obtained from the external authentication infrastructure apparatus 8 (Yes in S46), the account information updating unit 204 updates the account management table 212 by using cached information including the linkage partner account ID, an e-mail address, a name, and the like (S47). The user presence checking unit 203 notifies the user terminal apparatus 4B about an authentication result indicative of success of authentication and permits use of a subject service within a range of authority set for a tenant ID (S48).

In a case where it is determined in Step S44 that the linkage partner is not an outside, i.e., in a case where the linkage partner is local (No in S44), the user presence checking unit 203 determines that the user has an authority to use a subject service, notifies the user terminal apparatus 4B about an authentication result indicative of success of authentication, and permits use of the subject service within a range of authority set for a tenant ID (S48).

In a case where it is determined in Step S42 that there is no linkage partner account ID corresponding to the linkage source account ID (No in S42), the user presence checking unit 203 determines that the user does not have an authority to use a subject service and notifies the user terminal apparatus 4B about an authentication error (S49).

In a case where a response indicating that the user is present is not obtained in Step S46 (No in S46), the account information updating unit 204 updates the association information table 211 and the account management table 212 by deleting a record including the linkage partner account ID (S50). The user presence checking unit 203 determines that the user does not have an authority to use the subject service and notifies the user terminal apparatus 4B about an authentication error (S49).

### Modification 1

In the exemplary embodiment, the service providing apparatus 2 has the association information table 211, the account management table 212, and the access information table 213. However, a database server apparatus connected to the internal network 5 may have one or more of or all of these tables 211 through 213.

Although the exemplary embodiment of the present disclosure has been described above, the exemplary embodiment of the present disclosure is not limited to the above exemplary embodiment, and the exemplary embodiment can be modified in various ways without departing from the spirit of the present disclosure.

One or more of or all of the units of the controller 20 may be constituted by a hardware circuit such as a field programmable gate array (FPGA) or an application specific integrated circuit (ASIC).

Furthermore, one or more of the constituent elements according to the exemplary embodiment may be omitted or changed without departing from the spirit of the present disclosure. In the flows according to the exemplary embodiment, addition, deletion, change, replacement, and the like of a step can be made without departing from the spirit of the present disclosure. Furthermore, the program used in the above exemplary embodiment may be offered by being recorded on a computer-readable recording medium such as a CD-ROM. Furthermore, the program used in the exemplary embodiment may be stored in an external server such as a cloud server and used over a network.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a receiving unit that receives an authentication request using first account information identifying an account for use of a service provided by a linkage source; and
an inquiring unit that, in a case where the received first account information is associated with second account information identifying an account for use of a service provided by an external authentication apparatus, inquires the external authentication apparatus as to whether or not the second account information is registered.

2. The information processing apparatus according to claim 1, further comprising a memory in which the first account information, the second account information, and identification information for confirmation of registration of the second account information are stored in association with one another,
wherein the inquiring unit acquires, from the memory, the identification information for confirmation of registration that corresponds to the first account information received by the receiving unit and inquires the external authentication apparatus as to whether or not the second account information is registered on a basis of the identification information for confirmation of registration.

3. The information processing apparatus according to claim 1, further comprising a permission unit that permits use of a service provided by the information processing apparatus in a case where a response indicating that the second account information is registered is received from the external authentication apparatus.

4. The information processing apparatus according to claim 2, further comprising a permission unit that permits use of a service provided by the information processing apparatus in a case where a response indicating that the second account information is registered is received from the external authentication apparatus.

5. The information processing apparatus according to claim 3, wherein
the inquiring unit does not make the inquiry in a case where the first account information is associated with third account information identifying an account for use of a service provided by the information processing apparatus; and
the permission unit permits use of the service provided by the information processing apparatus.

6. The information processing apparatus according to claim 4, wherein
the inquiring unit does not make the inquiry in a case where the first account information is associated with third account information identifying an account for use of a service provided by the information processing apparatus; and
the permission unit permits use of the service provided by the information processing apparatus.

7. The information processing apparatus according to claim 3, wherein
in a case where a response indicating that the second account information is not registered is received from the external authentication apparatus, the permission unit does not permit use of the service provided by the information processing apparatus.

8. The information processing apparatus according to claim 4, wherein
in a case where a response indicating that the second account information is not registered is received from the external authentication apparatus, the permission unit does not permit use of the service provided by the information processing apparatus.

9. The information processing apparatus according to claim 5, wherein
in a case where a response indicating that the second account information is not registered is received from the external authentication apparatus, the permission unit does not permit use of the service provided by the information processing apparatus.

10. The information processing apparatus according to claim 6, wherein
in a case where a response indicating that the second account information is not registered is received from the external authentication apparatus, the permission unit does not permit use of the service provided by the information processing apparatus.

11. The information processing apparatus according to claim 7, further comprising an updating unit that updates the memory by deleting corresponding information from the memory in a case where a response indicating that the second account information is not registered is received from the external authentication apparatus.

12. The information processing apparatus according to claim 8, further comprising an updating unit that updates the memory by deleting corresponding information from the memory in a case where a response indicating that the second account information is not registered is received from the external authentication apparatus.

13. The information processing apparatus according to claim 9, further comprising an updating unit that updates the memory by deleting corresponding information from the memory in a case where a response indicating that the second account information is not registered is received from the external authentication apparatus.

14. The information processing apparatus according to claim 10, further comprising an updating unit that updates the memory by deleting corresponding information from the memory in a case where a response indicating that the second account information is not registered is received from the external authentication apparatus.

15. The information processing apparatus according to claim 2, wherein
the memory stores therein the first account information, the second account information, the identification information for confirmation of registration of the second account information, third account information identifying an account for use of a service provided by the information processing apparatus, and identification information for confirmation of registration of the third account information in association with one another; and
in a case where a plurality of pieces of identification information for confirmation of registration stored in the memory in association with the first account information received by the receiving unit are acquired, a selection screen prompting selection of any of the plurality of pieces of identification information for confirmation of registration is presented to an authentication requestor.

16. An information processing system comprising:
a memory in which first account information identifying an account for use of a service provided by a linkage source, second account information identifying an account for use of a service provided by an external authentication apparatus, and identification information for confirmation of registration of the second account information are stored in association with one another;
a receiving unit that receives an authentication request using the first account information; and
an inquiring unit that, in a case where the received first account information is associated with the second account information, acquires the identification information for confirmation of registration corresponding to the first account information from the memory and inquires the external authentication apparatus as to whether or not the second account information is registered on a basis of the identification information for confirmation of registration.

17. A non-transitory computer readable medium storing a program causing a computer to execute a process comprising:
receiving an authentication request using first account information identifying an account for use of a service provided by a linkage source; and
in a case where the received first account information is associated with second account information identifying an account for use of a service provided by an external authentication apparatus, inquiring the external authentication apparatus as to whether or not the second account information is registered.
